(19) United States
(12) Patent Application Publication
(10) Pub. No.: US 2023/0013097 A1
(43) Pub. Date: Jan. 19, 2023

(54) AUTOMATED GENERATION OF SERVICE ITEM RECOMMENDATIONS

(71) Applicant: ServiceTitan, Inc., Glendale, CA (US)

(72) Inventors: Eyal Binshtock, Glendale, CA (US); Lilit Ghukasyan, Glendale, CA (US); Tianyu Qiu, Glendale, CA (US)

(21) Appl. No.: 17/868,287

(22) Filed: Jul. 19, 2022

Related U.S. Application Data
(60) Provisional application No. 63/223,358, filed on Jul. 19, 2021.

(51) Int. Cl. G06Q 30/06; G06Q 30/04; G06N 3/04

(52) U.S. Cl. CPC G06Q 30/0631; G06N 3/04; G06Q 30/04; G06Q 30/0641

(57) ABSTRACT

The present invention relates to systems and methods for generating price book service item recommendations. A process of the disclosed technology includes steps for generating an estimate comprising one or more service items, based on selections at a user interface, analyzing the one or more service items to identify at least one recommended service item, generating a recommendation for the at least one additional service item, and presenting the recommendation on a display associated with the user interface. In various embodiments, a neural network can be applied to determine an association between the one or more service items and at least one additional service item based on a set of past invoices. Systems and machine-readable media are also provided.

### CROSS REFERENCE TO RELATED PATENT APPLICATION

This patent application claims the benefit under 35 U.S.C. § 119(e) of U.S. Pat. Application No. 63/223,358, entitled “Automated Generation of Service Item Recommendations”, filed on Jul. 19, 2021 which is incorporated herein by reference its entirety.

### TECHNICAL FIELD

The subject technology provides solutions for generating recommendations of relevant service items for estimates, and in particular generating tailored recommendations based on prior sales.

### BACKGROUND

In the service and repair industry, estimates are often created to provide customers with a quote for the product and service costs required by a particular job. Such estimates can be prepared electronically and utilize an electronic catalog comprising a plurality of available products and services. However, the creation of estimates can be tedious and inefficient since technicians must manually search for and add each item to an estimate. In addition, the technician must identify all items associated with the service, which requires extensive knowledge and memory of both the service being quoted and the electronic catalog, which may comprise hundreds or thousands of products and services. As a result, there is a need to ease the burden on the technician and provide improved, efficient methods for developing estimates.

### SUMMARY

Disclosed herein are systems and methods for automatically generating service item recommendations. Embodiments can comprise generating an estimate comprising one or more service items, based on selections at a user interface, analyzing the one or more service items to identify at least one recommended service item, generating a recommendation for the at least one additional service item, and presenting the recommendation on a display associated with the user interface. A neural network can be applied to determine an association between the one or more service items and at least one additional service item based on a set of past invoices.

In various embodiments, the association between the one or more service items and at least one additional service item can identify service items commonly sold together, and/or a manually-defined relationship between service items. Invoices utilized in the analysis each identify at least one sold service item.

In other embodiments, the neural network can comprise a plurality of layers to analyze items associated with past invoices and generate recommended items. The neural network can utilize a unique identifier associated with each service item, such as a stock-keeping unit (SKU) to identify and distinguish service items. In various embodiments, the set of past invoices represent at least one of: a time period, a season, a seasonality, a service region, and a type of service. The one or more service items can additionally be selected from a price book comprising a plurality of service items for purchase, as discussed herein.

It will be appreciated that embodiments in accordance with the present invention can utilize one or more computing devices, including but not limited to a mobile computing device, a smartphone, a tablet, and an interactive display, among others. In examples, recommended service items can be added to the estimate in response to a selection on a user interface, such as a touch screen user interface.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 illustrates an example user interface for generating estimates and recommendations, in accordance with various embodiments discussed herein.

FIG. 2 illustrates an example user interface providing service items in accordance with embodiments.

FIG. 3 illustrate another example user interface for providing and selecting service items in accordance with embodiments.

FIG. 4 illustrates an example of smart recommendations in accordance with embodiments.

FIG. 5 illustrates a neural network architecture in accordance with embodiments.

FIG. 6 illustrates an example recommendation generation in accordance with embodiments.

FIG. 7 illustrates a cloud computing system in accordance with embodiments.

FIG. 8 shows an example computing device which may be used to perform any of the techniques disclosed herein.

FIG. 9 illustrates a recommendation architecture in accordance with embodiments.

FIG. 10 illustrates a flowchart for recommendation generation in accordance with embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

The present systems and methods relate to systems and methods for generating service item recommendations. In an example, the service item recommendations, i.e., smart recommendations, can be presented when users or technicians prepare an estimate comprising service items. When the user selects at least one service item, the system can provide at least one recommended product or service, such as a product or service that is often sold with the initially selected item. The recommendations can be based off prior invoices, which are indicative of completed sales. A neural network can be implemented to analyze prior invoices and determine an association between service items. Service items can be a product or a service, and in embodiments, are stored in a price book comprising available service items. Various embodiments of the present technology are discussed herein.

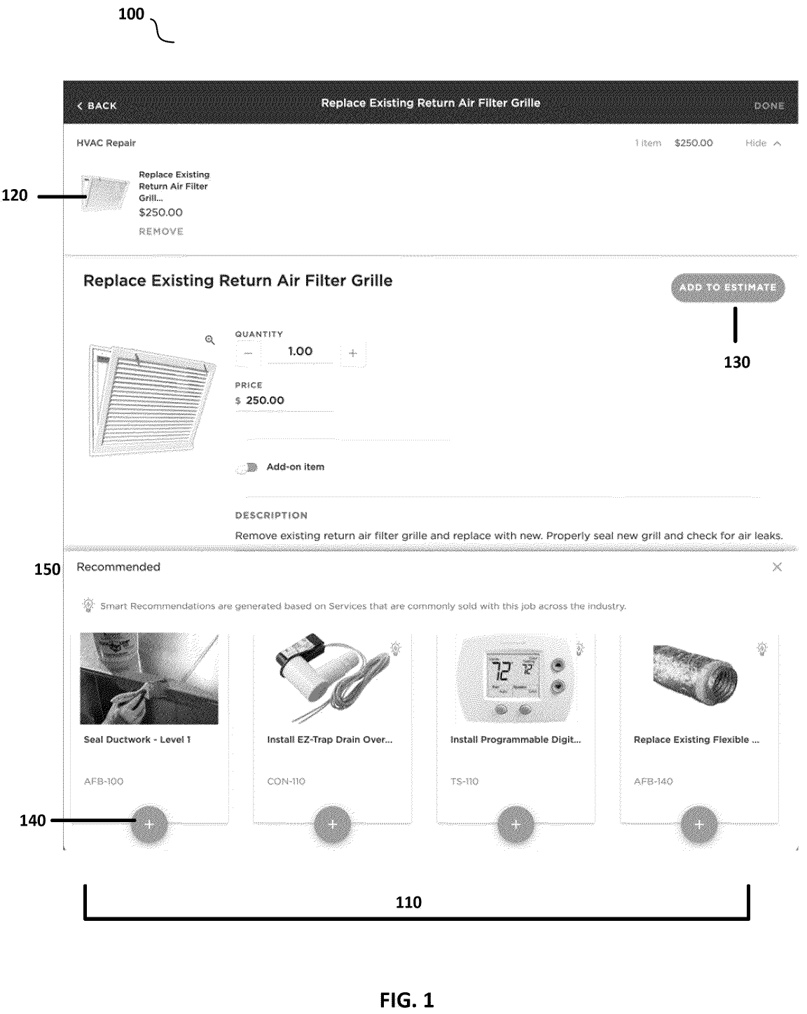

FIG. 1 illustrates an example interface for generating estimates 100. In embodiments, service items can be added to the estimate 130, e.g., via a touch selection, button, or other method to indicate a selection. The service item 120 can be a product or service available in a price book. A price book can be a catalog of available items for purchase, and can be stored locally, remotely, on a cloud database, or other accessible server. As discussed herein, estimates record what technicians recommend and invoices record what customers actually purchase. The estimate 100 can be presented via an application or display on a computing device, such as a mobile computing device, tablet, smart phone, or other general computing device associated with a display.

In FIG. 1, the service item, a replacement of an air filter grille can be further modified with customizations specific to the proposed job or service being quoted. Customizations can include price, quantity, indication of a type of item, e.g., an “add-on item,” and the like. The estimate display can additionally provide a description of the product, specifications, and other information. In embodiments, service items can be searched for and identified via a search function. Items can be identified via one or more unique identifiers, such as a name, stock-keeping unit (SKU), and the like. Search functions can search the price book comprising all available service items to identify the desired product or service that the user desires.

When at least one service item 120 is selected and added to the estimate, the present invention can provide one or more recommended service items 110 to be added to the estimate. The recommended items 110 can easily be added to the estimate via a selection button 140. In embodiments, when an additional service item is added to the estimate, the present technology can update its service item recommendations based on the addition of the new item.

In various embodiments, the recommendation feature utilizes prior invoices to determine related items for recommendations. Recommended items can be items that are commonly sold with the selected service item(s). In embodiments, the recommended items are specifically associated with the service items included in the estimate. As discussed below, recommended items can be selected based off a manually-defined associated between the items. For example, one or more service items in the price book may be linked such that when one service item is added to an estimate, the linked service items are presented as recommendations. As such, estimates can be prepared quicker and more efficiently, since commonly-related items are easily accessible by the user or technician preparing the estimate. Recommendations can further promote additional sales by providing recommendations for service items related to the estimate being prepared, and offering a convenient, easy method for users or technicians to identify and include related service items that the customer may be interested in, and service items that the customer may likely be interested in or need, based on the service items in the estimate.

In the illustrated example, the service item for replacing an existing return air filter grille has been identified, and added to the estimate. The smart recommendations are then presented at the bottom of the user interface. In the depicted example, four recommended service items are presented: Seal Ductwork, Installation of an EZ-Trap Drain, Installation of a Programmable Digital Thermostat, and Replacement of an Air Filter component. Each of the recommendations are services commonly associated with the replacement of an existing return air filter grille. The recommendations may be added to the estimate via button 140. In embodiments, users and technicians may be notified that the displayed service items are recommended items based on text identifying the service item recommendations as such. The service item recommendation display can, in embodiments, be a pop-up window. The service item recommendation can comprise a portion of the user interface, and can be minimized, moved, or otherwise altered, and are not limited to a specific display type or configuration on the user interface.

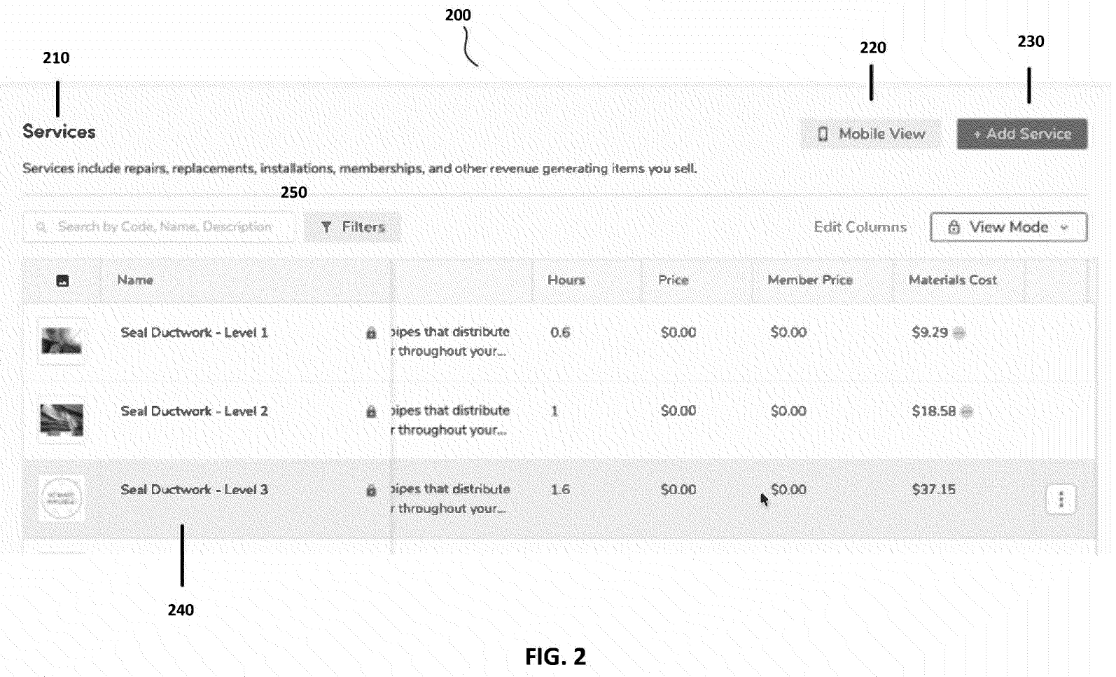

FIG. 2 illustrates another example of a user interface depicting a plurality of services that can be added to an estimate. In the illustrated view, the user interface can comprise a listing of services 210 that are associated with, and listed in, a price book. The services can be repairs, replacements, installations, memberships, and other revenue generating items.

Various embodiments of the user interface can comprise a toggle between a mobile view 220 and a desktop view. A search function 250 can be utilized to identify desired service items 240 to be edited and/or added to an estimate. The search function can comprise optional filters to further narrow the search for desired service items. Service items that match the search can provide additional information such as a name, description, estimated hours for completion, price, member price, materials cost, and so forth. A button to Add Service 230 can add the service item to an estimate.

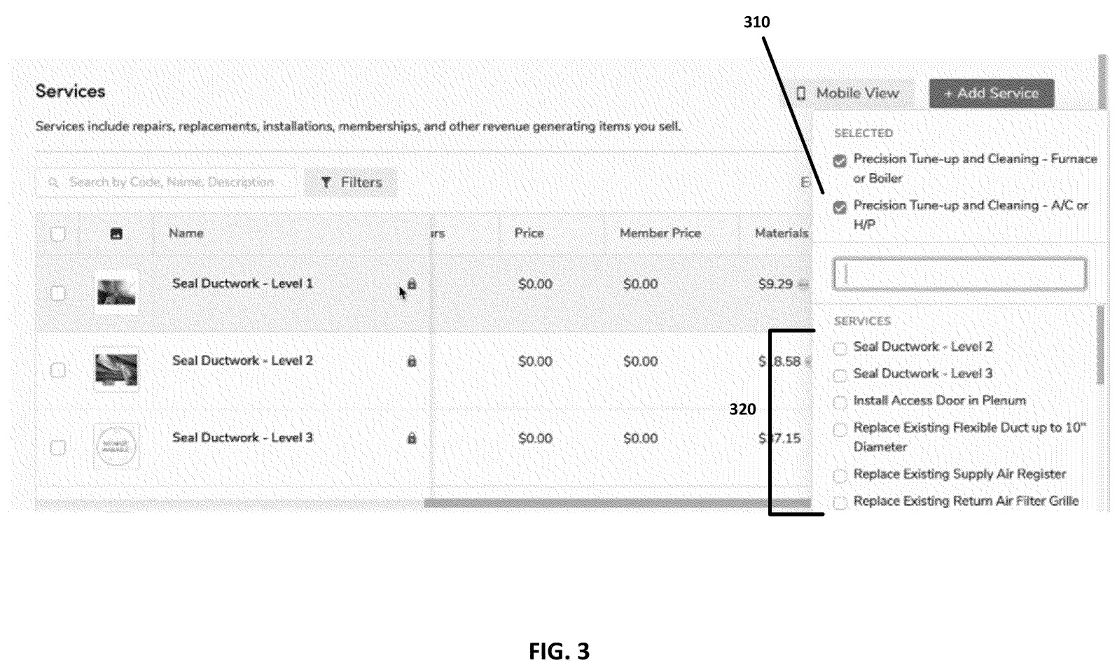

In embodiments, service items can be linked together to trigger a recommendation of the linked service item when a first service item is added to an estimate. FIG. 3 illustrates that multiple service items can be selected 310 out of a plurality of service items 320. In examples, selected service items can be linked together to assist with recommendations when users prepare estimates.

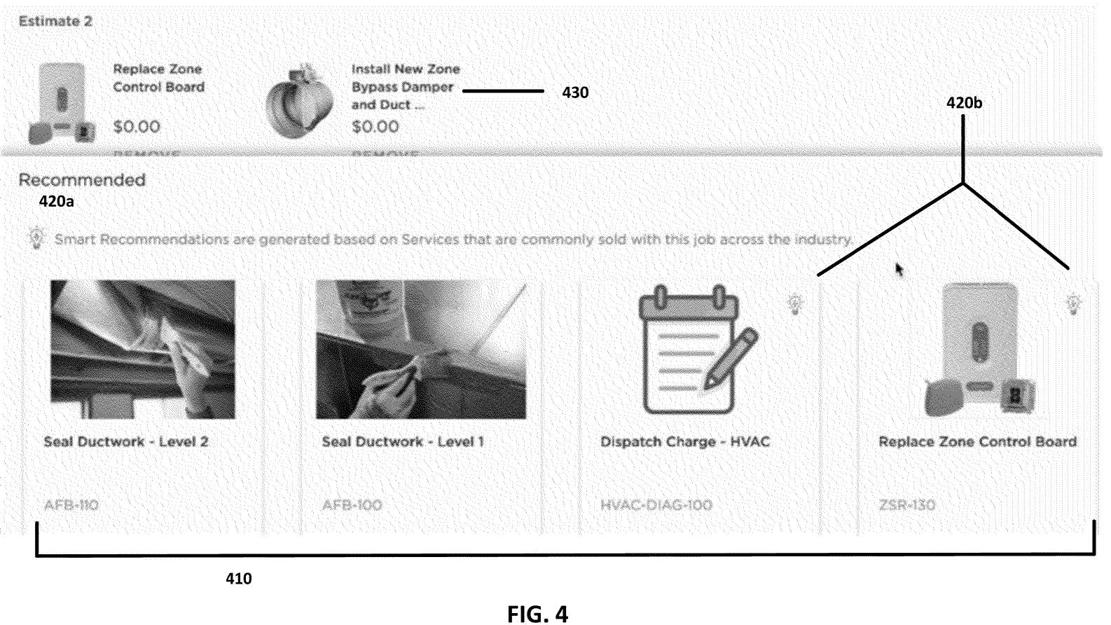

FIG. 4 illustrates an additional example of a smart recommendation that can be provided when at least one service item is added to an estimate. In the depicted example, two service items are added to the estimate 130. The added services items are “Replace Zone Control Board” and “Install New Zone Bypass Damper...” The recommendation window identifies four recommended items: Seal Ductwork - Level 2, Seal Ductwork - Level 1, Dispatch Charge -HVAC, and Replace Zone Control Board.

As discussed herein, the recommended service items can be recommended via a plurality of methods. In some examples, service items may be manually-defined to be linked together such that when a first service item is added to an estimate, its linked item(s) are suggested. In other examples, the recommendations can be smart recommendations, or recommendations that are automatically generated based on items that are commonly sold with the service item(s) in the estimate.

The recommendation window may denote the smart recommendations with a statement 420a and/or an icon 420b indicating that the associated items are generated based on services that are commonly sold with the job across the industry. As discussed herein, commonly sold items can be identified using a neural network analyzing invoices of items actually sold. In various embodiments, the neural network can analyze invoices and provide recommendations based on criteria comprising at least one of: a time period, a season, a seasonality, a service region, and a type of service. It will be appreciated that while the examples discussed herein describe utilizing invoices to analyze and determine commonly associated service items, systems and methods for generating recommendations need not be limited to invoices and service items actually sold. In various embodiments, the recommendations can be generated using one or more other criteria, such as past estimates, quotes, individually-tailored information, design preferences, and available information, among other things.

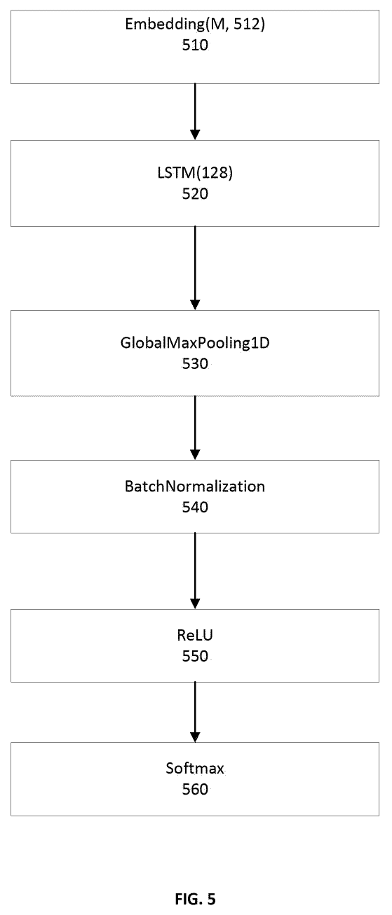

FIG. 5 illustrates an example neural network architecture that can be used to generate service item recommendations. As discussed herein, a price book curates and maintains a catalogue of popular service items. In embodiments, users can import these service items into their own price books and software usable to generate estimates. Service items can be associated with a unique identifier, such as a SKU, usable across multiple tenants and devices. The unique identifier can be used to allow a neural network to learn patterns across different tenants.

In embodiments, training data for the neural network can include all invoices and estimates. In examples, the training data can be customized to address a particular time range or starting at a particular data, e.g., the launch date of the price book. Training data can be modified to exclude certain data, such as invoices and/or estimates where technicians did not go to a customer’s location, or when the sale was not completed.

In the training step, the system analyzes service items in each invoice and/or estimate in the training data. In embodiments, training data is fed into the neural network in batches of 64 invoices/estimates. For each invoice/estimate, N service items are randomly selected and one of them is “masked”. The neural network will make a prediction based on the unmasked N-1 items and the result is compared with the actual item.

A loss function, such as Categorical Cross Entropy, can utilized in the neural network. A service item can be encoded into a 0/1 array based on its SKU identifier. For example, if the SKU is 2 and there are a total of 5 service items, then the service item can be encoded as [0 0 1 0 0], and the cross entropy can be defined as: sum_{i=1}^{total number of service items} (y_i * log(y _i)), where y_i is the 0/1 label. A lower categorical cross entropy (CCE) between prediction and actual indicates that the prediction is better. In embodiments, an optimizer, such as an Adam optimizer, can be used to tune neural network parameters in such a way that CCE is minimized.

As illustrated in FIG. 5, the neural network architecture can comprise a plurality of layers: Embedding(M, 512) 510, LSTM(128) 520, GlobalMaxPooling1D 530, Batch Normalization 540, ReLU 550, and Softmax 560, wherein M is the total number of service items, LSTM represents a Long short term memory layer, and ReLU represents a Rectified Linear Unit layer. In various embodiments a tensor flow implementation can be used in each layer.

In an example, when a technician selects at least one service item for an invoice/estimate, their selections are run through the neural network, which may be hosted locally or elsewhere. For example, the selections can be sent to AzureML, which can run the neural network, make a prediction, and return the result to the mobile device.

In other examples, non-neural networks can be utilized instead of or in addition to the above examples, in order to generate recommended service items. In an example, a non-neural network can utilize a co-occurrence matrix. In such embodiments, each invoice/estimate can be analyzed, and the number of times that service items appear together form the basis for a relationship between the service items. As such, the recommendation feature can fetch service items that co-occur most often with the selected item. In another non-limiting example, an embedding vector can be generated for each service items. Service items can be deemed to be related to each other when differences between corresponding vectors are below a threshold amount.

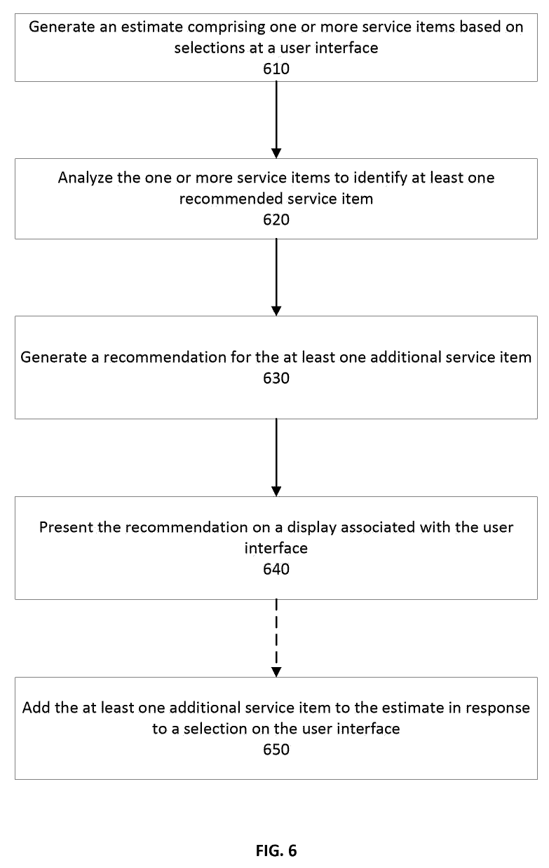

FIG. 6 illustrates an example method for generating a service item recommendation in accordance with embodiments discussed herein. Systems and methods can generate an estimate comprising one or more service items based on selections at a user interface 610. The user interface can be a computing device, mobile computing device, smart phone, tablet, interactive display device, and/or other graphical user interface. A user can search for and select service items based on any of the various examples discussed herein.

The one or more selected service items are analyzed to identify at least one recommended service item 620. As discussed herein a neural network, like the one described and discussed in FIG. 5, can assist in the analysis and identification of the at least one recommended service item 620. A recommendation for the at least one service item can be generated 630. The recommendation can be presented on a display associated with the user interface 640. In examples, the recommendation can be presented on a section, e.g., the bottom, of the user interface, as seen in the Figures shown and described herein. It will be appreciated that the recommendation is not limited to the examples illustrated herein and may be presented via a plurality of methods and means.

Optionally, the at least one additional service item can be added to the estimate in response to a selection on the user interface 650. While the recommended service items can be presented on the display associated with the user interface, its addition to the estimate is not required. The recommended service items can promote additional sales, and provide guidance, and recommendations to technicians regarding relevant service items. As such, estimate preparation can be improved, since service items commonly sold together can be identified, and easily added to the estimate.

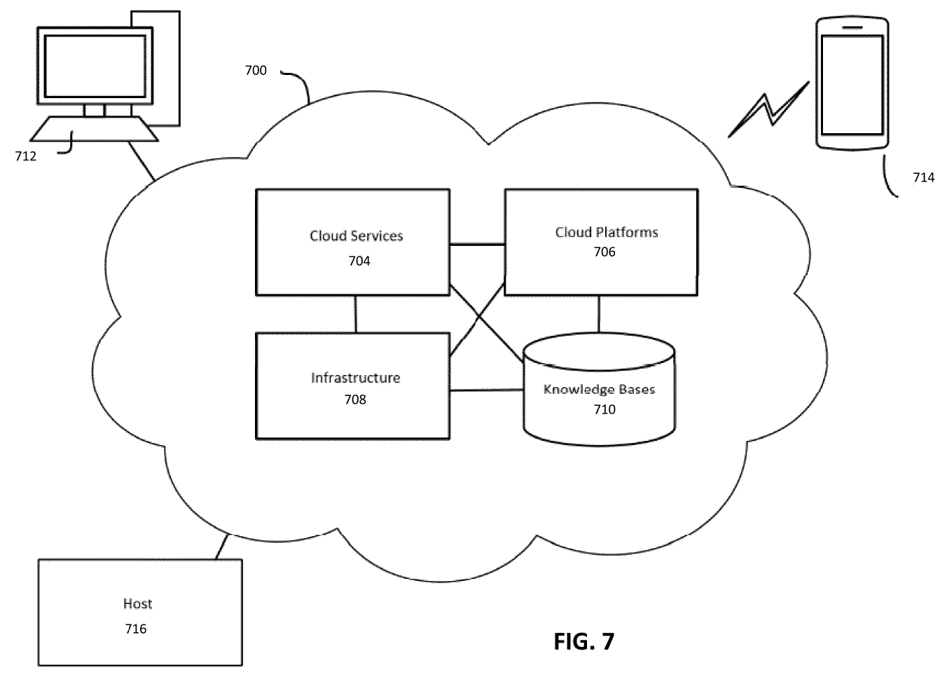

FIG. 7 shows example components of a cloud computing system 700. By way of example and without limitation, cloud computing system 700 may be used to perform aspects of the disclosed subject matter. Cloud-based computing generally refers to networked computer architectures where application execution, service provision, and data storage may be divided, to some extent, between clients and cloud computing devices. The “cloud” may refer to a service or a group of services accessible over a network, e.g., the Internet, by clients, server devices, and by other cloud computing systems, for example.

In one example, multiple computing devices connected to the cloud may access and use a common pool of computing power, services, applications, storage, and files. Thus, cloud computing enables a shared pool of configurable computing resources, e.g., networks, servers, storage, applications, and services, that may be provisioned and released with minimal management effort or interaction by the cloud service provider.

As an example, a cloud-based application may store copies of data and/or executable program code in the cloud computing system, while allowing client devices to download at least some of this data and program code as needed for execution at the client devices. In some examples, downloaded data and program code may be tailored to the capabilities of specific client devices, e.g., a personal computer, tablet computer, mobile phone, and/or smartphone, accessing the cloud-based application. Additionally, dividing application execution and storage between client devices and the cloud computing system allows more processing to be performed by the cloud computing system, thereby taking advantage of the cloud computing system’s processing power and capability, for example.

Cloud-based computing can also refer to distributed computing architectures where data and program code for cloud-based applications are shared between one or more client devices and/or cloud computing devices on a near real-time basis. Portions of this data and program code may be dynamically delivered, as needed or otherwise, to various clients accessing the cloud-based application. Details of the cloud-based computing architecture may be largely transparent to users of client devices. By way of example and without limitation, a PC user device accessing a cloud-based application may not be aware that the PC downloads program logic and/or data from the cloud computing system, or that the PC offloads processing or storage functions to the cloud computing system, for example.

In FIG. 7, cloud computing system 700 includes one or more cloud services 74, one or more cloud platforms 706, cloud infrastructure components 708, and cloud knowledge bases 710. Cloud computing system 700 may include more of fewer components, and each of cloud services 704, cloud platforms 706, cloud infrastructure components 708, and cloud knowledge bases 710 may include multiple computing and storage elements as well. Thus, one or more of the described functions of cloud computing system 700 may be divided into additional functional or physical components or combined into fewer functional or physical components. In some further examples, additional functional and/or physical components may be added to the examples shown in FIG. 7. Delivery of cloud computing-based services may involve multiple cloud components communicating with each other over application programming interfaces, such as web services and multi-tier architectures, for example.

Example cloud computing system 700 shown in FIG. 7 is a networked computing architecture. Cloud services 704 may represent queues for handling requests from client devices. Cloud platforms 706 may include client-interface frontends for cloud computing system 700, such as client-interface frontends of a messaging service. Cloud platforms 706 may be coupled to cloud services 704 to perform functions for interacting with client devices. Cloud infrastructure 708 may include service, billing, and other operational and infrastructure components of cloud computing system 700. Cloud knowledge bases 710 are configured to store data for use by cloud computing system 700, and thus, cloud knowledge bases 710 may be accessed by any of cloud services 704, cloud platforms 706, and/or cloud infrastructure components 708.

Many different types of client devices, such as devices of users of the messaging service, may be configured to communicate with components of cloud computing system 700 for the purpose of accessing data and executing applications provided by cloud computing system 700. For example, a computer 712, a mobile device 714, and a host 716 are shown as examples of the types of client devices that may be configured to communicate with cloud computing system 700. Of course, more or fewer client devices may communicate with cloud computing system 700. In addition, other types of client devices may also be configured to communicate with cloud computing system 700 as well.

Computer 712 shown in FIG. 7 may be any type of computing device, e.g., PC, laptop computer, tablet computer, etc., and mobile device 714 may be any type of mobile computing device, e.g., laptop, smartphone, mobile telephone, cellular telephone, tablet computer, etc., configured to transmit and/or receive data to and/or from cloud computing system 100. Similarly, host 716 may be any type of computing device with a transmitter/receiver including a laptop computer, a mobile telephone, a smartphone, a tablet computer etc., which is configured to transmit/receive data to/from cloud computing system 700.

In FIG. 7, communication links between client devices and cloud 700 may include wired connections, such as a serial or parallel bus, Ethernet, optical connections, or other type of wired connection. Communication links may also be wireless links, such as Bluetooth, IEEE 802.11 (IEEE 802.11 may refer to IEEE 802.11-2007, IEEE 802.11n-2009, or any other IEEE 802.11 revision), CDMA, 3G, GSM, WiMAX, or other wireless based data communication links.

In other examples, the client devices may be configured to communicate with cloud computing system 100 via wireless access points. Access points may take various forms. For example, an access point may take the form of a wireless access point (WAP) or wireless router. As another example, if a client device connects using a cellular air-interface protocol, such as CDMA, GSM, 3G, or 4G, an access point may be a base station in a cellular network that provides Internet connectivity via the cellular network.

As such, the client devices may include a wired or wireless network interface through which the client devices may connect to cloud computing system 700 directly or via access points. As an example, the client devices may be configured to use one or more protocols such as 802.11, 802.16 (WiMAX), LTE, GSM, GPRS, CDMA, EV-DO, and/or HSPDA, among others. Furthermore, the client devices may be configured to use multiple wired and/or wireless protocols, such as “3G” or “4G” data connectivity using a cellular communication protocol, e.g., CDMA, GSM, or WiMAX, as well as for “WiFi” connectivity using 802.11. Other types of communications interfaces and protocols could be used as well.

The above-described aspects of the disclosure have been described with regard to certain examples and embodiments, which are intended to illustrate but not to limit the disclosure. It should be appreciated that the subject matter presented herein may be implemented as a computer process, a computer-controlled apparatus or a computing system or an article of manufacture, such as a computer-readable storage medium.

Those skilled in the art will also appreciate that the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, cellular telephone devices, biometric devices, mobile computing devices, special-purposed hardware devices, network appliances, and the like. The embodiments described herein may also be practiced in distributed computing environments, where tasks are performed by remote processing devices that are linked through a communications network. In a distributed computing environment, program modules may be located in both local and remote memory storage devices.

A number of different types of computing devices may be used singly or in combination to implement the resources and services in different embodiments, including general-purpose or special-purpose computer servers, storage devices, network devices, and the like. In at least some embodiments, a server or computing device that implements at least a portion of one or more of the technologies described herein, including the techniques to implement the functionality of aspects discussed herein.

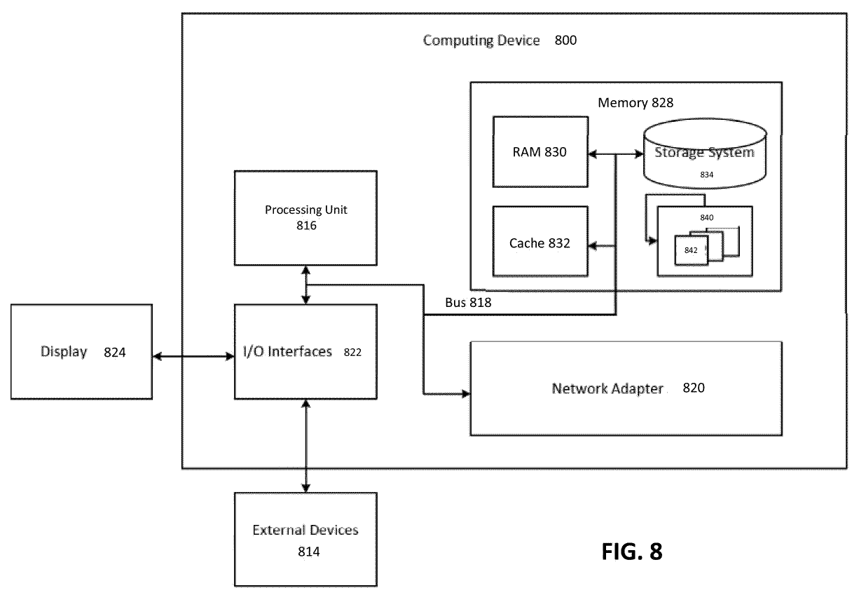

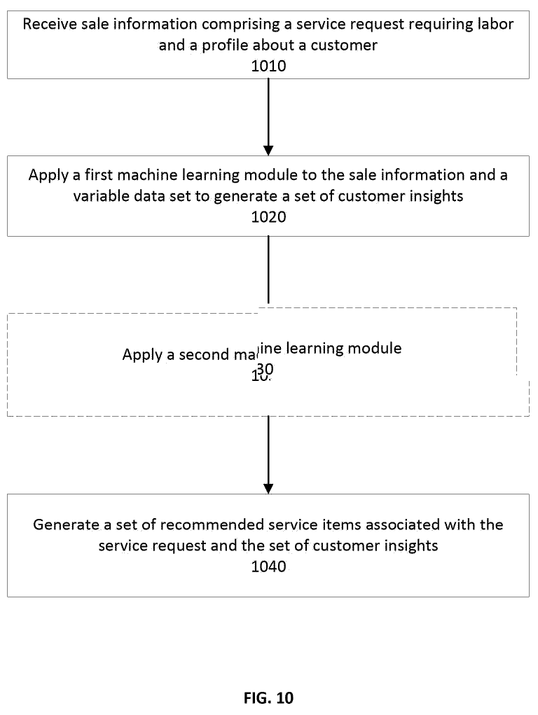

FIG. 8 shows such a general-purpose computing device 800. The computing device 800 may operate in a virtual environment, such as the environment 1000 in FIG. 10. Computing device 800 may be used to host the messaging service or the messaging application. Computing device 800 may be configured to communicate with devices of users of the messaging application. Computing device 800 may be a general-purpose computing device. Computing device 800 may be an on-premises device, such as a node of a distributed system running in a user’s data center. The components of computing device 800 may include, but are not limited to, one or more processors or processing units 816, a system memory 828, and a bus 818 that couples various system components including system memory 828 to processor 816.

The bus 818 in the example of FIG. 8 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (“ISA”) bus, Micro Channel Architecture (“MCA”) bus, Enhanced ISA (“EISA”) bus, Video Electronics Standards Association (“VESA”) local bus, and Peripheral Component Interconnects (“PCI”) bus.

Computing device 800 may include a variety of computer system readable media. Such media may be any available media that is accessible by computing device 800, and it includes both volatile and non-volatile media, removable and non-removable media. Computing device 800 may include system memory 828, which may include computer system readable media in the form of volatile memory, such as random-access memory (“RAM”) 830 and/or cache memory 832. Computing device 800 may further include other removable/non-removable, volatile/non-volatile computer system storage media. By way of example only, a storage system 834 may be provided for reading from and writing to a non-removable, non-volatile magnetic media (not shown and typically called a “hard drive”). Although not shown, a magnetic disk drive for reading from and writing to a removable, non-volatile magnetic disk, e.g., a “floppy disk,” and an optical disk drive for reading from or writing to a removable, non-volatile optical disk such as a CD-ROM, DVD-ROM or other optical media may be provided. In such instances, each may be connected to bus 818 by one or more data media interfaces. As will be further depicted and described below, memory 828 may include at least one program product having a set, e.g., at least one, of program modules that are configured to carry out the functions of embodiments of the invention.

Computing device 800 may include a program/utility 840 having a set (at least one) of program modules 842 that may be stored in memory 828. Computing device 800 of FIG. 8 may also include an operating system, one or more messaging application programs, other messaging application program modules, and messaging application program data. Each of the operating system, one or more messaging application programs, other messaging application program modules, and messaging application program data or some combination thereof, may include an implementation of a networking environment, such as the cloud computing system 100 in FIG. 1. Program modules 842 generally carry out the functions and/or methodologies of embodiments of the invention as described herein.

Computing device 800 of FIG. 8 may also communicate with one or more external devices 814 such as a keyboard, a pointing device, a display 824, and so on that enable a user to interact with computing device 800. Computing device 800 may also include any devices, e.g., network card, modem, etc., that enable computing device 800 to communicate with one or more other computing devices. Such communication may occur, for example, via I/O interfaces 821. Still yet, computing device 800 may communicate with one or more networks such as a local area network (“LAN”), a general wide area network (“WAN”), and/or a public network, e.g., the Internet, via network adapter 820. As depicted, network adapter 820 communicates with the other components of computing device 800 via bus 818. It should be understood that although not shown, other hardware and/or software components could be used in conjunction with computing device 800. Examples include, but are not limited to, microcode, device drivers, redundant processing units, external disk drive arrays, RAID systems, tape drives, and data archival storage systems, and so on.

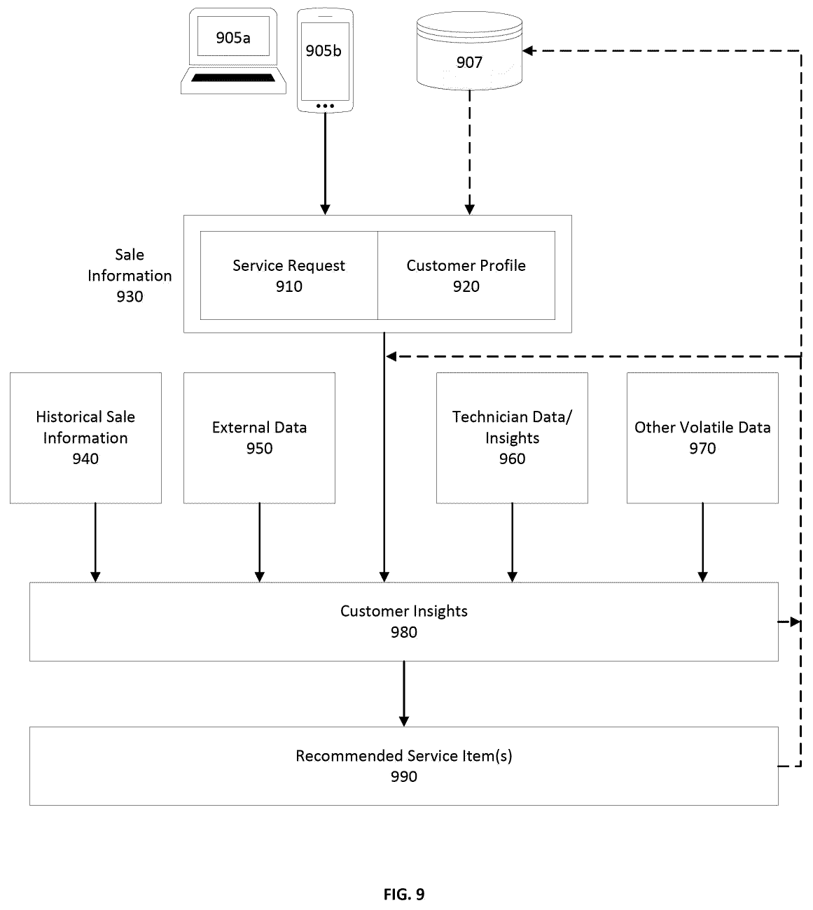

FIG. 9 illustrates an example architecture for generating recommended service items, in accordance with embodiments discussed herein. A computing device 905a, which may be a mobile computing device 905b can provide information indicative of sale information 930. The computing device(s) 905a, 905b may be associated with a customer, such as a customer entering information on a laptop or smartphone related to a service request inquiry requiring labor.

The inquiry may include sale information 930 comprising a service request 910 and a customer profile 920. A database 907 storing previously collected information may provide additional information related to at least one of the service request 910 and the customer profile 920. The service request 910, as discussed herein, can be a job, service, installation, and the like requiring technician labor. Such example may include but are not limited to construction, repair, renovation, installation, or other mechanical, electrical, home, business, and other services. Often, such service requests will require one or more service items, which may include but are not limited to products, devices, operations, workflows, tasks, and other items related to the request.

The customer profile 920 comprises information known and/or collected about the customer. The profile may include at least one of a name, location, past services rendered, past services requested, manually-entered information about the customer (e.g., from a customer representative, the customers themselves, etc.), information collected about the customer (e.g., from third party sources), a transaction history associated with the customer, and the like. As noted above, at least one database can provide information relating to at least one of the customer profiles, the service request, and sale information.

The sale information 930, along with one or more variable datasets can generate customer insights 980 and a set of recommended service items 990, as discussed herein. At least one machine learning module may be applied to generate the customer insights 980. Similarly, at least one machine learning module may generate the set of recommended service items 990 based on the customer insights. In some embodiments, as single machine learning module may generate both customer insights 980 and recommended service items 990. As discussed herein, machine learning modules may include at least one neural network to ingest data various data sets and provide recommendations. Machine learning modules may be trained, at least in part, using results from the generated customer insights and recommendations. Other training sets may include collected sale information, service requests, customer profile information, completed sales, previously generated quotes, estimates or recommendations, and one or more of the variable data sets discussed herein. Machine learning models may also utilize one or more optimization techniques to generate predictions and estimates for recommendations and insights. It will be appreciated that one of ordinary skill in the art may implement a range of machine learning techniques, modules, and combinations, depending on the desired customer insights and types of services and service items related to embodiments.

Turning to customer insights 980, the sale information 930 and at least one variable data set may generate customer insights and recommended service items 990.

Variable data sets refer to non-static data sets. Non-static data sets contain information which may be volatile, and can drastically change based on one or more factors, which may not be easily traceable, trackable, or relatable to the output data point. In embodiments, variable data sets are continuously refreshed, and may be refreshed in real-time, at certain time intervals (e.g., 1 day, 1 week, 1 month, etc.), manually or based on other preferences and considerations.

Traditional recommendation modules avoid using highly variable datasets, since the volatility creates challenges in prediction consistency and result reliability. However, using at least one variable data set, along with the sale information 930 discussed herein, unique customer insights may be generated and utilized to further generate recommended service items 990.

Variable data sets may include historical sale information 940, external data 950, technician data/insights 960, and other volatile information 970. As discussed herein, variable data sets may utilize one or more machine learning algorithms to tailor predictions and insights from the data set to a particular item or category of interest. It will also be appreciated that the volatile data sets may be used as training data in one or more machine learning networks, neural networks, and the like as discussed herein. Any or all of such data and data sets may be stored within one or more storages/databases, such as database 907.

Historical sale information 940 may include data from at least one of the present customer, a set of customers, a technician, a set of technicians, past sales, one or more services or items associates with a sale, job, estimate, quote, and the like. Historical sale information in accordance with embodiments may or may not be a completed sale, but will comprise information associated with a sale, service request, labor task, or job associated with the present sale information 930.

External data 940 includes data obtained from an external source. In embodiments, the external source may be a third party, such as a third-party data source, a website, catalog, collection, and the like. In some embodiments, external data may include at least one of a weather prediction, a seasonality, service item availability, technician availability, supply chain information, and cost information. In an example, weather prediction(s) may be used in the recommendation process to tailor certain items or services. For example, if the sale information included a service request that required a dry area of installation, weather data could provide insights into an upcoming period or season of wet weather, and recommend alternative products, services, or installation dates, among others.

In other examples, a seasonality may be a consideration for the recommendation process. Some products and/or services may be more common in certain seasons, months, time periods, and the like, and such information may influence whether those products and/or services may be recommended. For example, if the service inquiry relates to HVAC tasks, air conditioning units may be in greater demand during the summer months, while heating systems and components may be in greater demand during the winter months. The seasonality information of those parts may be taken into account, when services and service items are being recommended.

External data may further incorporate supply chain data and implement analyses, which may be useful in generating customer insights and service item recommendations. For example, supply chain information can provide information about a service item’s availability, a technician availability, cost information, timing information, etc.

As an example, in the summer, demand for air conditioner servicing may be high, and service technician availability limited. If a certain brand or model of air conditioner units are delayed or otherwise unavailable, embodiments may ingest such supply chain information, along with the customer information, to determine a best course of action for the service request. For example, customer insights might indicate that one particular customer would prefer a faster installation timeline, while another would be more likely to delay installation to ensure a particular brand, price point, or technology. External supply chain information can be combined with such insights to generate recommended product(s) and service(s) to fulfill the service request.

Technician data/insights 960 may relate to at least one of technician expertise, completed service requests associated with a technician, a set of service items associated with completed service requests, technician availability, current schedule, and the like. Technician insights may be generated using a technician profile, e.g., based on previously generated or known information about the technician, and optionally using one or more volatile data sets, and machine learning algorithms like the customer insight generation. Since the technician insights vary based one completed services, expertise, and other factors, and may continuously change, it may be considered a variable dataset, as discussed herein.

Other volatile information 970 includes any data sets that may be continuously refreshed, changed, and applicable to the service request 910 and customer profile 920. Information may include product ratings, which may change over time. Ratings, when combined with customer information, for example, may provide customer insights as to types of products the customer would be likely to buy, as well as a likelihood for such products. A set of recommended products may be provided, and include a qualitative ranking, such as “good, better, best”, “most recommended” and the like. In another example, results from prior campaigns, sales, discounts, etc., may provide insights as when to provide offers/incentives to consumer and/or which approaches were successful.

Similarly, volatile information, can be useful to identify consumer trends, tailor offers and incentives to certain customers, provide feedback from one or more customer or demographic groups, estimate a budget range, estimate a likelihood that a consumer will purchase a particular service (e.g., a propensity to finance a project, service, etc.), product or item availability, and any of a plurality of customer insights and service item recommendations.

As illustrated in FIG. 9, the sale information 930 and at least one variable data set generate customer insights 980. The customer insights may include but are not limited to buyer traits. Such traits can include a likelihood to purchase a type of product, financial information, such as a predicted budget range for the consumer, a propensity to finance, a desired maintenance level, technology interests, desired features, and incentives that may be enticing to the consumer. Incentives may include an offer, discount, type of product (e.g., low energy, low cost, low environmental impact, particular brand, model etc.), etc., and provide insights to encourage commitment and completion of the sale and service request.

Based on the customer insights, a set comprising one or more recommended service items 990 may be generated, and utilized in one or more aspects, as discussed herein (see, e.g., FIGS. 5-6). In various embodiments, customer insights 980 and service item recommendations 990 may occur sequentially or concurrently.

With reference to FIG. 5, once a service item, e.g., a labor task, product, or service, is identified, a recommendation for an additional service item may be generated. In embodiments, the recommended service item may be based on the set of recommended service items 990. In some embodiments, associations between recommended service items may be stored (e.g., in database 907) and used for one or more subsequent customer insight analyses and service item recommendations. It should also be appreciated that associations between service items may be stored and utilized in one or more volatile data sets, machine learning modules, training sets, and the like. As such, interactions and operation of the systems and methods discussed herein improve subsequent insight and recommendations, as models are continuously obtaining new data and retraining based on the updated information.

FIG. 10 illustrates a flowchart for generating a set of recommended service items. At block 1010, sale information is received. As discussed herein, sale information may comprise a service request requiring labor and a profile about a customer. The service request may optionally provide one or more products or tasks associated with the request. The customer profile may comprise any of a plurality of collected, received, or manually entered information about a customer, including but not limited to demographic information, historical purchases, products, and interests, among others.

At block 1020, a first machine learning module may be applied to the sale information and a variable data set to generate a set of customer insights. Variable data may include at least one data set related to external information (e.g., weather, stocks, item availability, seasonality, supply chain information, cost information, etc.), customer information (e.g., preferences, past purchases, known information, etc.), and technician information (e.g., expertise, current schedule/availability, completed jobs/service requests, rating, preferred products, items associated with the technician’s past jobs/service requests, etc.). The variable data set can also comprise at least one of information previously collected about the customer, and information previously collected about the service request. Customer insights can include at least one of a likelihood for the customer to purchase a type of product, a budget range, a propensity to finance, and an incentive for the customer.

At block 1030, a second machine learning module may be optionally applied in accordance with block 1040, wherein a set of recommended service are generated. The set of recommended service items are associated with the service request and the set of customer insights, as discussed herein. It will be appreciated that the one or more machine learning modules may implement blocks 1020-1040, such that customer insights and recommended service items may be generated.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various generalpurpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language, and it is appreciated that a variety of programming languages may be used to implement the teachings of the present invention as described herein, and any references to a specific language or languages are provided for illustrative purposes only and for enablement of the contemplated best mode of the invention at the time of filing.

Conditional language used herein, such as, among others, “can,” “could” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A system for generating price book service item recommendations, comprising: one or more processors; and
a computer-readable medium comprising instructions stored therein, which when executed by the processors, cause the processors to perform operations comprising:
generating an estimate comprising one or more service items, based on selections at a user interface;
analyzing the one or more service items to identify at least one recommended service item;
generating a recommendation for the at least one additional service item; and
presenting the recommendation on a display associated with the user interface.

2. The system of claim 1, wherein analyzing the one or more service items comprises: applying a neural network to determine an association between the one or more service items and at least one additional service item based on a set of past invoices.

3. The system of claim 2, wherein the association identifies service items commonly sold together.

4. The system of claim 2, wherein the association identifies a manually-defined relationship between service items.

5. The system of claim 2, wherein each invoice identifies at least one sold service item.

6. The system of claim 2, wherein the neural network utilizes a unique identifier associated with each service item.

7. The system of claim 2, wherein the set of past invoices represent at least one of: a time period, a season, a service region, and a type of service.

8. The system of claim 1, wherein the one or more service items are selected from a price book comprising a plurality of service items for purchase.

9. The system of claim 1, wherein the user interface is at least one of: a mobile computing device, a smartphone, a tablet, and an interactive display.

10. The system of claim 1, further comprising adding the at least one additional service item to the estimate in response to a selection on the user interface.

11. A computer-implemented method for generating price book service item recommendations, comprising:
generating an estimate comprising one or more service items, based on selections at a user interface;
analyzing the one or more service items to identify at least one recommended service item;
generating a recommendation for the at least one additional service item; and
presenting the recommendation on a display associated with the user interface.

12. The computer-implemented method of claim 11, analyzing the one or more service items comprises: applying a neural network to determine an association between the one or more service items and at least one additional service item based on a set of past invoices.

13. The computer-implemented method of claim 11, wherein the association identifies at least one of: service items commonly sold together and a manually-defined relationship between service items.

14. The computer-implemented method of claim 12, wherein each invoice identifies at least one sold service item, and the neural network utilizes a unique identifier associated with each service item.

15. The computer-implemented method of claim 12, wherein the set of past invoices represent at least one of: a time period, a season, a service region, and a type of service.

16. The computer-implemented method of claim 11, wherein the user interface is at least one of: a mobile computing device, a smartphone, a tablet, and an interactive display.

17. The computer-implemented method of claim 11, further comprising adding the at least one additional service item to the estimate in response to a selection on the user interface.

18. A non-transitory computer-readable storage medium comprising instructions stored therein, which when executed by one or more processors, cause the processors to perform operations comprising:
generating an estimate comprising one or more service items, based on selections at a user interface;
analyzing the one or more service items to identify at least one recommended service item;
generating a recommendation for the at least one additional service item; and
presenting the recommendation on the user interface.

19. The non-transitory computer-readable storage medium of claim 18, wherein the instructions for analyzing the one or more service items further comprises: applying a neural network to determine an association between the one or more service items and at least one additional service item based on a set of past invoices.

20. The non-transitory computer-readable storage medium of claim 18, wherein the association identifies at least one of: service items commonly sold together and a manually-defined relationship between service items.

22. The system claim 1, further comprising:
receiving, from at least one remote computing device, sale information comprising a service request requiring labor, and a profile about a customer;
applying a first machine learning module to the sale information and a variable data set to generate a set of customer insights; and
generating a set of recommended service items associated with the service request and the set of customer insights.

23. The system of claim 22, wherein the variable data sets are continuously refreshed, in real-time.

24. The system of claim 22, wherein the variable data sets comprise at least one of a set of external information and technician insights.

25. The system of claim 24, wherein the set of external information comprises at least one of a weather prediction, a seasonality, a service item availability, technician availability, supply chain information, and cost information.

26. The system of claim 24, wherein the technician insights relate to at least one of technician expertise, completed service requests associated with a technician, a set of service items associated with completed service requests.

27. The system of claim 22, further comprising applying a second machine learning module to generate the set of recommended service items.

28. The system of claim 22, wherein customer insights comprise at least one of: a likelihood to purchase a type of product, a budget range, a propensity to finance, and an incentive for the customer.

29. The system of claim 22, wherein the variable data set comprises at least one of: information previously collected about the customer and information previously collected about the service request.
